(19) United States
(12) Patent Application Publication
(10) Pub. No.: US 2022/0245467 A1
(43) Pub. Date: Aug. 4, 2022

(54) METHODS AND APPARATUS FOR RETRIEVING RELEVANT INFORMATION FROM AN UNSTRUCTURED KNOWLEDGE BASE

(71) Applicant: Walmart Apollo, LLC, Bentonville, AR (US)

(72) Inventors: Snehasish Mukherjee, Santa Clara, CA (US); Haoxuan Chen, Mountain View, CA (US); Lakshmi Manasa Velaga, Dublin, CA (US); Akshay Kumar, Sanganer (IN)

(21) Appl. No.: 17/162,970

(22) Filed: Jan. 29, 2021

(51) Int. Cl. G06N 5/02; G06F 16/22; G06F 16/2458; G06F 16/2457; G06F 16/955

(52) U.S. Cl. CPC G06N 5/022; G06F 16/2228; G06F 16/955; G06F 16/24578; G06F 16/2458

(57) ABSTRACT

The disclosed subject matter relates to a system and method for retrieving relevant information in response to a user query without devising intent of the query. The relevant information is contained within a semi-structured database which was populated from Q&A pairs, help web sites, product descriptions and other information from an organizations knowledge base and from which an inverted index is created. The semi-structured data base may be created automatically or entered manually. Upon receiving a user query, data segments are identified (and ranked) via the inverse index and the data segment most similar to the query is provided to a MRC model which reads the segments to determine the portion (span/snippet) of the data segment that addresses the query. This portion is provided to the user in response to the query.

### TECHNICAL FIELD

The disclosed subject matter relates generally to web based question and answering systems and methods of answering questions without recognizing intent.

### BACKGROUND

Presently, most intent driven question answering systems require the developer to upload example phrases and train a natural language understanding (NLU) model to recognize the intent. Once the intent is recognized, developers need to build the conversation flow graph. The conversation flow graph determines how that intent is to be processed and what response to generate. While, a vast majority of conversational use cases lend themselves naturally to such intent-based flows, these systems are inefficient for use cases that require automatic question answering based upon semi-structured knowledge bases. Examples of such semi-structured knowledge bases are frequently asked questions (FAQs) and help pages typically used by retailers and other types of organizations present on the web.

To address this known inefficiency of intent-based flows for question answering from semi-structured knowledge bases, there exist a need for a Q&A system that is intent free and thus avoids the associated resources required in devising such intent. In addition there is a need to capture and exploit the information contained in existing semi-structured knowledge bases for use in such a Q & A system such that available resources may be efficiently leveraged in creating the semi-structured knowledge base. In response to this recognized need, a Q&A system has been developed where developers may simply provide the root URL for their knowledge base, or a list of question and answer pairs that preferably are already existent. The disclosed subject matter as described herein ingests this data to auto-generate a Q&A model that can answer user's questions based on the information present in the knowledge base, or, give up if the current user question cannot be answered from the discrete knowledge base.

### SUMMARY

The embodiments described herein are directed to a system and method for generating answers from a semi-structured knowledge base without deriving intent of the questions. In addition to or instead of the advantages presented herein, persons of ordinary skill in the art would recognize and appreciate other advantages as well.

In accordance with various embodiments, exemplary systems may be implemented in any suitable hardware or hardware and software, such as in any suitable computing device.

In some embodiments, a system includes a computing device operably connected to first and second databases, and is configured to receive a query from a user; identify a segment of the data in the first database that is most similar to the received query. In these embodiments, the computing device operates on (reads) the identified data segment using a machine reading comprehension module to identify a span of the identified data segment that is most relevant to the user query, and then transmits the identified span to the user. The computing device in these embodiments may also be configured to receive data from a semi-structured knowledge base, such as questions and answer pairs or from a website describing the subject matter of the anticipated questions. The computing device may also be configured to create an inverted index from the data segments and store the inverted index in the second database, such that the index may be searched for relevant data segments in the first database.

In some embodiments, a method is provided that provides relevant information in response to a query without determining intent. The method includes receiving a query from a user; identifying a data segment from a plurality of data segments in a semi-structured database that is similar to the query; and transmitting the data segment to a machine reading comprehension module. The machine reading comprehension modules operates on (reads) the identified data segment; identifies a span of the identified data segment most relevant to the user query, and provides the span to the user. The method may also include receiving data from a semi-structured knowledge base; storing the received data in a database and creating an inverted index of the data segments and saving the inverted index in an index database for later use in identifying data segment.

In yet other embodiments, a non-transitory computer readable medium having instructions stored thereon is provided. The instructions, when executed by at least one processor, cause a device to perform operations comprising: receiving a query from a user; accessing an index database and identifying a data segment from a plurality of data segments in an semi-structured database that is similar to the query. The instruction also cause the processor to perform the operations of transmitting the identified data segment to a machine reading comprehension module; reading the identified data segment with the machine reading comprehension module; identifying a span of the identified data segment most relevant to the user query, and, transmitting the span to the user. The operations may also include receiving data from a semi-structured knowledge base; storing the received data in a database and creating an inverted index of the data segments and saving the inverted index in an index database prior to identifying data segments relevant to the query.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of communication network used to answer questions in accordance with some embodiments;

FIG. 2 is a block diagram of the intent free question answering computing device of the communication system of FIG. 1 in accordance with some embodiments;

FIG. 3 is a diagram of operations carried out by the an intent-free question answering computing device and communication system of FIGS. 1 and 2 in accordance with embodiments of the disclosed subject matter;

FIG. 4 is a diagram of operations carried out by the intent-free questing answering computing device and communication systems of FIGS. 1 and 2 in creating the knowledge base within the database and the associated inverted index in accordance with embodiments of the disclosed subject matter: and,

FIG. 5 is a flowchart of a method of retrieving relevant information in response to a query without determining intent in accordance with embodiments of the disclosed subject matter.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

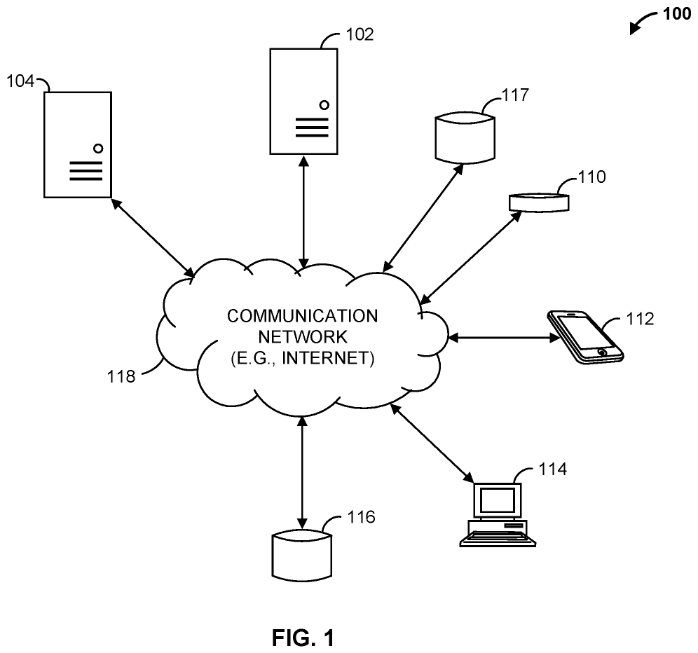

Turning to the drawings, FIG. 1 illustrates a block diagram of a communication system 100 that includes an intent-free question answering computing device 102 (e.g., a server, such as an application server), a web server 104, database 116 and index storage 117, and multiple customer computing devices 110, 112, 114 operatively coupled over network 118.

An intent free answering computing device 102, server 104, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, or through the communication network 118.

In some examples, the intent-free answering computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, intent-free answering computing device 102, and web server 104 are operated by a retailer, and multiple customer computing devices 112, 114 are operated by customers of the retailer.

Although FIG. 1 illustrates three customer computing devices 110, 112, 114, advertisement system 100 can include any number of customer computing devices 110, 112, 114. Similarly, the communication system 100 can include any number of workstation(s) (not shown), intent free answering computing devices 102, web servers 104, and databases 116 and 117.

The intent free question answering computing device 102 is operable to communicate with databases 116 and index storage 117 over communication network 118. For example, intent-free question answering computing device 102 can store data to, and read data from, databases 116 and 117. Databases 116, 117 may be remote storage devices, such as a cloud-based server, a disk (e.g., a hard disk), a memory device on another application server, a networked computer, or any other suitable remote storage. Although shown remote to the intent-free question answering computing device 102, in some examples, databases 116 and 117 may be a local storage device, such as a hard drive, a non-volatile memory, or a USB stick. The intent free question answering computing device 102 may store data from workstations or the web server 104 in database 116. In some examples, storage devices store instructions that, when executed by intent free question answering computing device 102, allow intent free answering computing device 102 to determine one or more s results in response to a user query.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

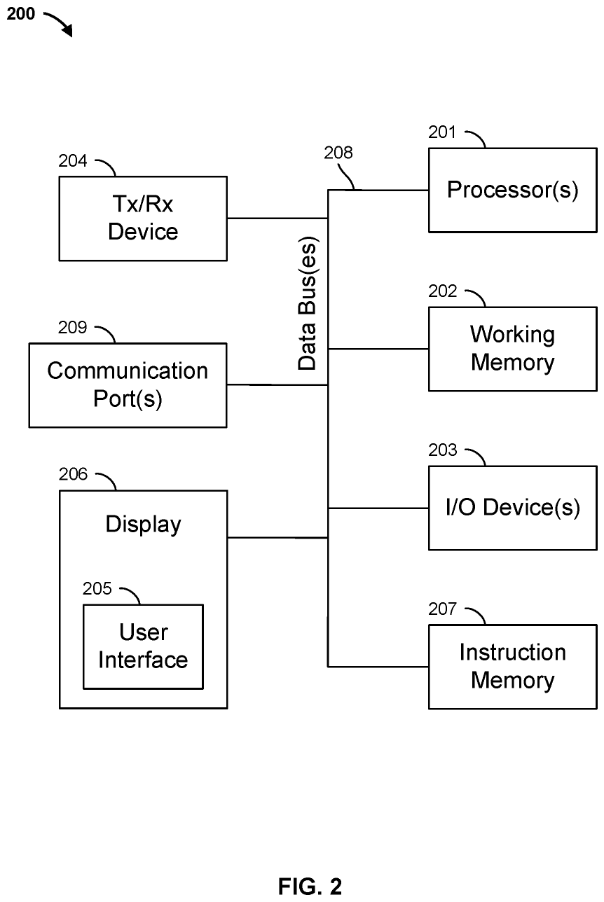

FIG. 2 illustrates the intent free question answering computing device 102 of FIG. 1. Intent free question answering computing device 102 may include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more processing cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of intent free answering computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning algorithm training data.

Display 206 can display user interface 205. User interfaces 205 can enable user interaction with intent free question answering computing device 102. In some examples, a user can interact with user interface 205 by engaging input-output devices 203. In some examples, display 206 can be a touchscreen, where user interface 205 is displayed by the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 intent free question answering computing device 102 will be operating in. Processor(s) 201 is operable to receive data from, or send data to, a network, such as communication network 118 of FIG. 1, via transceiver 204.

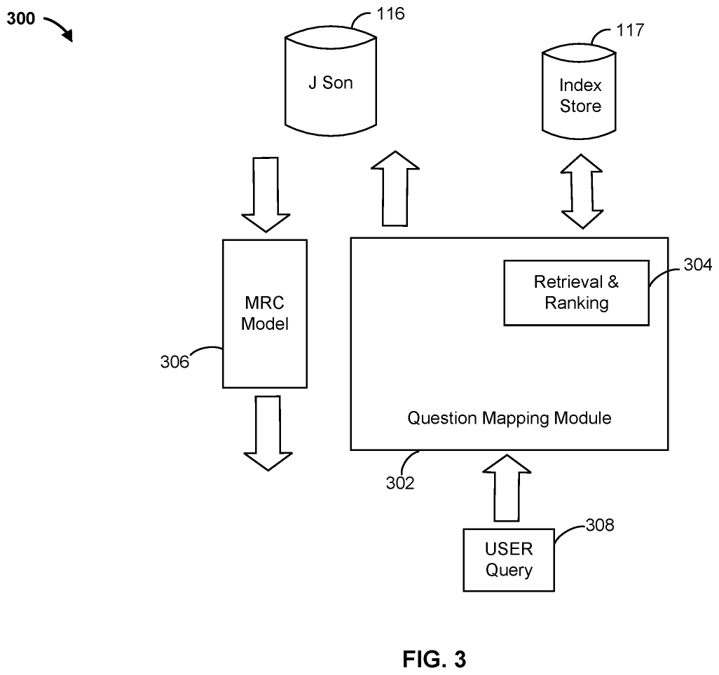

FIG. 3 illustrates a schematic diagram 300 of the operations of the intent-free question answering computing device 102 in retrieving relevant information from the semi structured knowledge base stored in the database 116. The question mapping module 302 receives live or queued user queries 308. The queries may be received online, telephonically or via a dedicated workstation. The mapping module 302 accesses the index store 117 to identify if the user query is similar to any question in the semi structured knowledge base. In one embodiment an ensemble of a Bidirectional Encoder Representations for Transformers (BERT) question similarity model and a non-stochastic retrieval based module may be used. BERT is a deep learning model that provides results on a wide variety of natural language processing tasks. The retrieval module 304 uses a statistical measure that evaluates how relevant a word is to a document in a collection of documents. This is done for example by multiplying two metrics: how many times a word appears in a document, and the inverse document frequency of the word across a set of documents, tf-idf is an example of a statistic based retrieval and ranking algorithm that may be employed in the current subject matter. The retrieval module 304 accesses the inverted index store 117 to find the most relevant Q&A pair (data segment) from the stored knowledge base.in database 116. The identified question and answer pair, or data segment(s) that is determined to be statistically similar to the query via the inverted index, is then retrieved from the database 116. In the embodiment shown, the information in the database 116 is in the form of a JSON. JSON is an open standard format that uses human-readable text to transmit data objects consisting of attribute-value pairs. A JSON object (data segment), as shown below from an extracted Q&A pair, may include several fields, url, title, question, ans etc.
{‘url’:‘https://help.walmart.com/article/refilling-prescriptions/962c1201600340962f92576c4ba0045? title=Refilling %20Prescriptions’,
‘title’: ‘Refilling Prescriptions’,
‘question’: ‘Find Prescription Number and Expiration Date.’,
‘ans_start’: “The prescription number is on the last prescription filled. It's a 7-digit number located on the left side,?near the top of the label. The expiration date is at the bottom of the prescription label.”,
‘ans’: “The prescription number is on the last prescription filled. It's a 7-digit number located on the left side, near?the top of the label. The expiration date is at the bottom of the prescription label.”,
‘html’: ‘<h2 data-mce-style=“user-select: auto;” style=“user-select: auto” >Find Prescription Number and Expiration Date</h2> <p style=“user-select: auto” data-mce-style=“user-select: auto;” > The prescription number is on the last prescription filled.? It\'s a 7-digit number located on the left side, near the top of the label. The expiration date is at the bottom of the prescription label.</p>’,
‘docId’: ‘221’

The relevant JSON object (data segment) from the knowledge base 116, specifically the answer field in the example provided from that JSON is then passed on to a pre-trained machine reading comprehension (MRC) model 306 that extracts the portion in the answer that accurately answers the user query. MRC models are known in the art and thus are not described further. The MRC model 306, upon identifying the portion of the answer field that addresses the query, sends the span/snippet (the portion that contains the answer) to the user and in some embodiments returns the span to the database 116, where it replaces the content of the ans_start field in the identified JSON data segment.

For example where the user query is “Where can I find the expiration date on my prescription?” and the above JSON data segment was determined the most similar, the MRC model 306 would receive the ans field:
“The prescription number is on the last prescription filled. It's a 7-digit number located on the left side, near?the top of the label. The expiration date is at the bottom of the prescription label;”

and would determine the span:
“the expiration date is at the bottom of the prescription label”
as the portion of the data segment that addresses the query. The MRC model 306 would provide the span in response to the user query and in some embodiments replace the ans_start field in the data segment with the span.

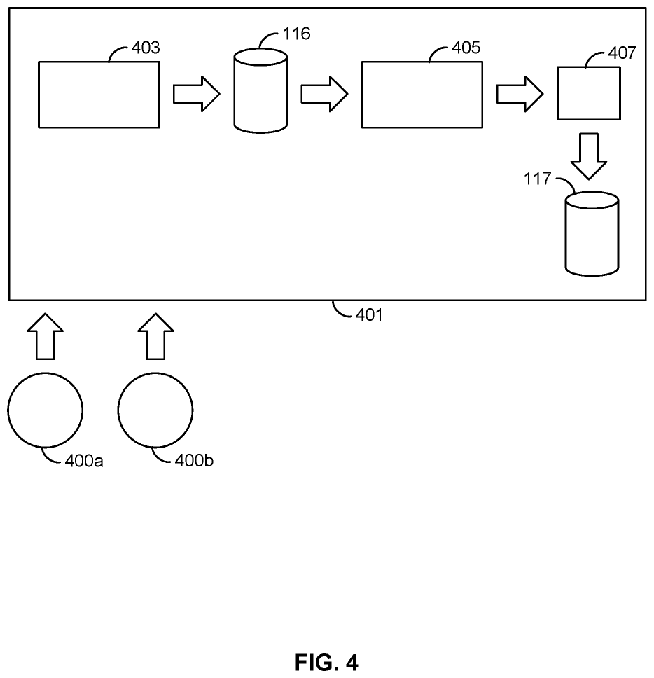

FIG. 4 is a diagram of the ingestion of the semi-structured knowledge base into database 116 and the index store 117. As used herein the term semi-structured data/knowledge is a form of structured data that is not restrained to the tabular structure of data models associated with relational databases or other forms of data tables, but nonetheless contains tags or other markers to separate semantic elements and enforce hierarchies of records and fields within the data, such data structure is also known as self-describing structure. As noted above semi-structured knowledge bases may be pre-existent in the form of FAQ, help pages, articles, product/services descriptions etc. typically used by retailers and other types of organizations with presence on the web.

The semi-structured knowledge base may be manually or automatically entered into the database 116. Embodiments may include the use of a crawler and scraper to extract data in accordance with authorization/permissions from the data owner. In the case the data is in a URL, the URL that points to the root of the knowledge base is registered. The KB/FAQ ingestion module 401, which may be in the form of a polymorphic indexing service, starts by crawling the root URL to a certain depth as provided and authorized by developer/URL custodian 400a. Specified patterns of URLs are explored. If no patterns are provided, URLs are only explored till a predefined depth, or URLs may be provided from a list. For each URL, the page HTML is parsed to automatically extract probable (question, answer) pairs and several other metadata, like the raw html content etc. from that page. The output of the crawler and scraper module 403 stage is a list of JSON objects, similar to the JSON object described previously.

This list of JSON is stored in the database 116. An index builder 405 constructs an inverted index 407 from JSON fields, for example the title, question and ans fields of each of the JSONs stored in the datable 116. An inverted index as known in the art is an index data structure storing a mapping from content, such as words or numbers, to its locations in a document or a set of documents, the keys for this index may be bigrams and trigrams extracted from these fields, while the values in the example are sets of docIds (location) that contain the key (content). The inverted index is stored in the index store 117. Domain developers 400b may also provide a manually generated list of Q&A pairs to the ingestion module 401 and thereafter in the same nature as the JSON described above. If such a list is entered instead of an URL, then the crawling and scraping process would not be necessary and the data may be saved directly to the database 116, and would subsequently be used to create the inverted index 407 as stored in database 117 in the same manner as described above.

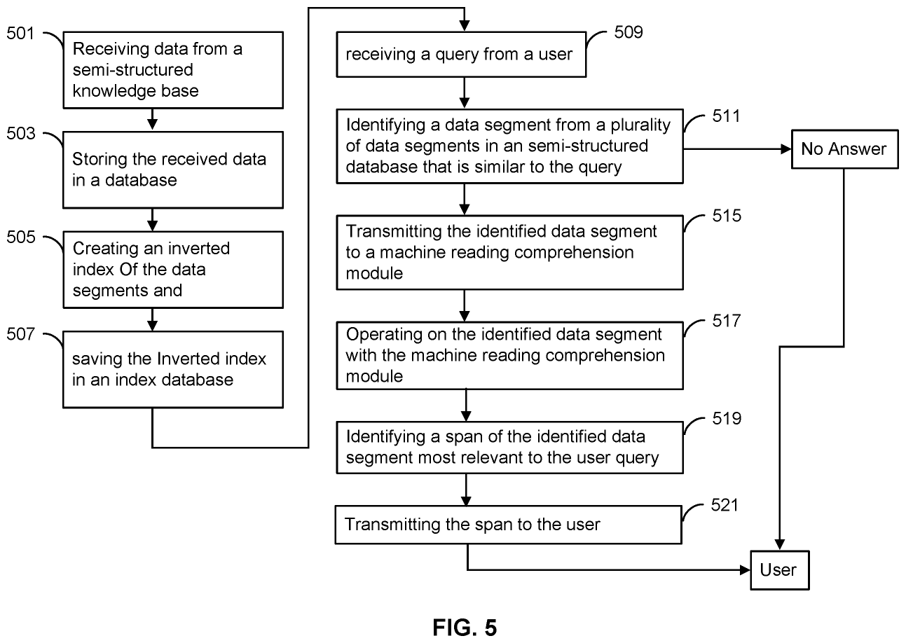

Turning to FIG. 5, starting from semi-structured data, the method allows customer queries to be answered by returning relevant information, without the need to determine the intent of the question, is shown. Data is received from a knowledge base as shown in block 501, the data may be received via crawling or scraping, or entered manually as described above. The data may be semi-structured, or if not it may be processed into a semi-structured format, such as JSON, XML etc. The transformation of text data into a semi-structured form is known in the art and thus not discuss further, natural language processing techniques, such as segmenting, normalizing etc. may be used in order to create the objects (data segments) of the semi-structured form. The semi-structured data is then stored in the database 116 as shown in block 503. An inverted index of the data segments is created as shown in block 505 and stored in index store (database) 117 as shown in block 507. The inclusion of the knowledge base in the database 116 and the creation of an inverted index, is generally a precursor to answering a question in accordance with the disclosed subject matter.

In block 509, a user query is received by the computing device 102. One or more data segments from the plurality of data segments stored in the semi-structured database is identified based on its similarity to the user query as shown in block 511. If no similar questions are found in the semi-structured database 116, then a no answer response is returned to the user as shown in block 513. If more than one data segment is identified, then the segments may be ranked, with the processing being carried forward with the most similar (highest ranking) data segment. The identified data segment is transmitted from the database 116 to the machine reading comprehension model 306 as shown in block 515. The MRC model 306 operates (reads) on the identified data segment as shown in block 517, and identifies a span or snippet of the data segment most relevant to answering the user query as shown in block 519. For example, the MRC model 306 identifies the sentences or phrases within the answer field that answers the user query. The selected span may be a portion of the answer field or may represent the entire field, but in any event will come entirely from the identified data segment.

The span selected by the MRC model 306 is then transmitted to the user 523 as an answer to the query as shown in block 521. The span may be inserted into a specific form prior to transmission to the user. In some embodiments the user query and identified span are fed back to the database 116 to augment the semi-structured knowledge base.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system for retrieving information from a semi-structured knowledge base without determining intent comprising:
a computing device operably connected to a first data base and a second data base, the computing device configured to:
receive a query from a user;
identify a data segment from a plurality of data segments in the first database that is similar to the query;
operate on the identified data segment with the machine reading comprehension module;
identify a span of the identified data segment most relevant to the user query; and,
transmit the identified span to the user.

2. The system of claim 1, wherein the computing device is further configured to receive data from a semi-structured knowledge base;
create an inverted index of the data segments; and,
storing the inverted index in the second database.

3. The system of claim 2, wherein the unstructured knowledge base is a plurality of URLs.

4. The system of claim 2, wherein the computing devices is further configures to create the inverted index from the title, question and answer fields of the data segments.

5. The system of claim 1, wherein the database is a JSON database.

6. The system of claim 2, the computing device further configured to segment the received data into the plurality of data segments.

7. The system of claim 1, the computing device further configured to rank two or more identified data segments.

8. A method of providing relevant information in response to a query without determining intent, comprising:
receiving a query from a user;
identifying a data segment from a plurality of data segments in an semi-structured database that is similar to the query;
transmitting the identified data segment to a machine reading comprehension module;
operating on the identified data segment with the machine reading comprehension module;
identifying a span of the identified data segment most relevant to the user query; and,
transmitting the span to the user.

9. The method of claim 8 further comprising:
receiving data from a semi-structured knowledge base;
storing the received data in a database creating an inverted index of the data segments and saving the inverted index in an index database.

10. The method of claim 8, wherein the unstructured knowledge base is a plurality of question and answer pairs.

11. The method of claim 8, wherein the unstructured knowledge base is a plurality of URLs.

12. The method of claim 11, wherein the step of receiving data comprising obtaining the URLs and extracting the data from the URLs.

13. The method of claim 12, wherein the extracted data includes title, question and answer fields.

14. The method of claim 13, wherein the inverted index is created from the title, question and answer fields.

15. The method of claim 10, wherein the invented index is created from the question and answer pairs.

16. The method of claim 9, wherein the database is a JSON database.

17. The method of claim 9, further comprising segmenting the received data into the plurality of data segments.

18. The method of claim 8, wherein the step of identifying the data segment comprises ranking two or more identified data segments.

19. A non-transitory computer readable medium having instructions stored thereon, wherein the instructions, when executed by at least one processor, cause a device to perform operations comprising:
receiving a query from a user;
accessing an index database and identifying a data segment from a plurality of data segments in an semi-structured database that is similar to the query without determining the intent of the user query;
transmitting the identified data segment to a machine reading comprehension module;
operating on the identified data segment with the machine reading comprehension module;
identifying a span of the identified data segment most relevant to the user query; and,
transmitting the span to the user.

20. The not-transitory computer readable medium of claim 19, further comprising the operations of:
receiving data from a semi-structured knowledge base;
storing the received data in a database;
creating an inverted index of the data segments; and,
saving the inverted index in an index database.
